(19) United States
(12) Patent Application Publication
(10) Pub. No.: US 2009/0000671 A1
(43) Pub. Date: Jan. 1, 2009

(54) DISHWASHER WITH INTEGRATED LIQUID LEVEL DETECTOR

(76) Inventor: Luca Montagnana, Via Trieste (IT)

Correspondence Address: THOMPSON HINE LLP;Intellectual Property Group, P.O Box 8801, DAYTON, OH, 45401-8801, US

(21) Appl. No.: 12/163,075

(22) Filed: Jun. 27, 2008

(30) Foreign Application Priority Data
Jun. 29, 2007 (IT) TO 2007A 000474

(51) Int. Cl. F16K 21/00; B08B 3/04

(52) U.S. Cl. 137/403; 134/56 D

(57) ABSTRACT

A device for detecting the liquid level in a tank of an electric household appliance includes an airtight bell connected on one side to the tank and on the opposite side to a pressure switch by means of a hose-carrier nipple. As the water level of the tank increases, the pressure of the air trapped in the bell increases, which is detected by the pressure switch. The airtight bell is defined by a rectilinear tube which obliquely protrudes from underneath the tank and externally to the same, towards a front panel of a casing of the household appliance for convenient access and easy cleaning. A shielding means within the tank is arranged in front the rectilinear tube to create a siphon between the bell and the tank and to prevent the water level in the tube from dropping past a minimum point.

### TECHNICAL FIELD

The present invention relates to a device for detecting the liquid level in a tank of an electric appliance, in particular a dishwashing machine, integrated with the tank itself and/or with the sump of the tank so as to reduce the dimensions thereof. The invention further relates to an electric household appliance, in particular to a dishwashing machine for professional use, including such a device.

### BACKGROUND

It is known that dishwashing machines, in particular those for professional use (for bars, restaurants, communities, etc.) present a washing compartment inferiorly delimited by a used washing fluid collection tank, from which an overflow tube draws, which maintains the level of the washing fluid in the tank constant. Furthermore, a sump which is normally used to aspirate part of the liquid in the tank and to recirculate it towards the washing/rinsing showerheads arranged inside the washing compartment and/or for draining the used liquid is arranged immediately underneath the tank.

In all cases, it is necessary to accurately check the liquid level in the tank, and this is performed by detecting such a liquid level by means of a level sensor arranged in the tank itself. According to EP-A-1758497, the level sensor is based on a floating system, arranged for drawing into the tank. Alternatively, according to EP-A-1352605, an air-tight bell is used, again arranged in the tank, within which the liquid level rises, along with that of the tank, but compressing the air trapped in the top of the bell in use; the latter is then connected by means of a hose carrier nipple and an appropriate flexible tube to a pressure sensor which, on the basis of the pressure of the air trapped inside the bell emits an electric signal which is proportional to the liquid level in the tank.

The above-described solutions are relatively cumbersome and are difficult to assemble and maintain. The presence of the bell (or, even worse, of the float) is a real hindrance when cleaning the tank. Additionally, since the bell is normally positioned at the rear part of the machine, to clean or maintain the bell requires that the dishwashing machine must be turned around and the rear panel of the casing of the electric household appliance must be removed.

It would be desirable to provide a device for detecting the liquid level in a tank of an electric household appliance, in particular a dishwashing machine, which is free from the above mentioned drawbacks and at the same time reliable, compact, simple, and relatively cost-effective to be made and assembled. It would also be desirable for this device to be easy to maintain and to avoid creating hard-to-clean areas or undesired obstructions in the tank.

### SUMMARY

The device includes an airtight bell connected on one side to the tank and on the opposite side to a pressure switch by means of a hose-carrier nipple. The airtight bell is defined by a rectilinear tube designed to obliquely protrude from underneath the tank towards a front panel of a casing of the household appliance. A screw-on cap, facing the front panel, is provided with the hose-carrier nipple for connection to the pressure switch. In use, the cap forms a fluid-tight seal that closes a first end of the rectilinear tube. A second end of the rectilinear tube, opposite to the first, is hydraulically connected to the tank substantially at a bottom wall of the talk but without protruding into the tank.

Preferably, the rectilinear tube is integrally formed as a unitary part of the sump for the tank, which is arranged immediately underneath a bottom wall of the tank. The rectilinear tube includes an outlet opening arranged flush with the internal surface of the side wall of the sump. The rectilinear tube, positioned obliquely relative to the side wall, protrudes upwards and laterally on the outside of the sump and at least in part under the tank.

In this manner, the tank does not present irregularities, cleaning is simple without unintentionally tampering with the bell (or with the float) and the volumes and assembly times of the level detecting device and of the dishwashing machine as a whole are greatly reduced.

This solution, specifically when the rectilinear tube is integrated with the sump, is extremely simple and functional. If the pressure inlet needs to be cleaned, it is necessary only to remove the front panel of the electric household appliance, which is an easy and simple operation, and loosen the screw cap, either by hand or with the simple support of a wrench.

For this purpose, the hose-carrier nipple preferably protrudes axially from the bottom wall of the screw-on cap, which is cup-shaped. The hose carrier is positioned externally to the screw-on cap and in an offset position with respect to the rectilinear tube, preferably in a symmetric position with respect to a cylindrical pin which also protrudes axially from bottom wall of the screw-on cap, parallel to the hose-carrier nipple.

### BRIEF DESCRIPTION OF THE DRAWINGS

FIG. 1 shows an elevational, front view of a dishwashing machine equipped with a liquid level detecting device.

FIG. 2 shows an elevational, partial longitudinal-section side view according to a plotting plane II-II of the dishwashing machine in FIG. 1.

### DETAILED DESCRIPTION OF THE INVENTION

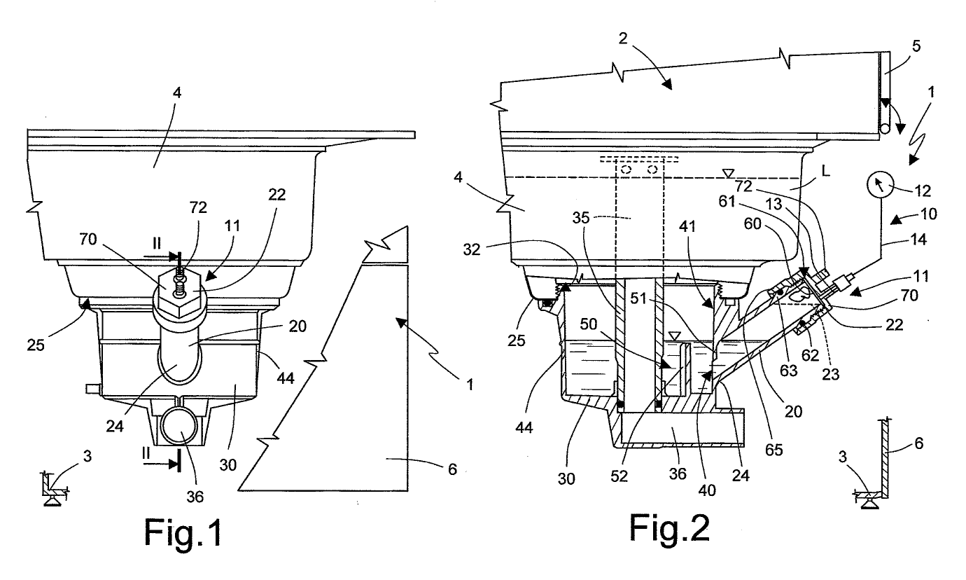

As shown in FIGS. 1 and 2, a dishwashing machine 1 for professional use comprises a washing compartment 2 delimited by a casing 3 and a collection tank 4 for a washing fluid. The washing compartment 2 is accessible through a front door 5 of the casing 3. The front door 5 is arranged above a removable front buffering panel 6 of the casing 3. The panel 6 is arranged in front of the collection tank 4.

The dishwashing machine 1 comprises a device 10 for detecting the level of a liquid L present in use in the collection tank 4, which level is diagrammatically shown by means of a dashed line in FIG. 2 according to two possible heights it may reach in the collection tank 4.

The device 10 is also accommodated in the casing 3 and comprises in turn an airtight bell 11 connected on one side to the tank 4 and on the other side to a pressure switch 12 by means of a hose-carrier nipple 13 onto which a tube 14 (only diagrammatically shown) is fitted, which connects the internal top of the bell 11 to the pressure switch 12 allowing the latter, in a known manner, to detect the pressure of the air trapped inside the bell 11 and therefore to provide a control system (known and not shown) of the dishwasher 1 with an electric signal which is proportional to the level of the liquid L present in the tank 4.

The airtight bell 11 is defined by a rectilinear tube 20 specifically designed to obliquely protrude upwards from underneath the tank 4 and externally to the same towards the removable front panel 6 and by a screw-on cap 22 externally provided with the nipple 13 for the connection to the pressure switch 12. The screw-on cap 22 provides a fluid-tight seal that closes a first end 23 of the rectilinear tube 20 facing the front panel 6.

A second end 24 of the rectilinear tube 20, opposite the end 23, is hydraulically connected essentially at a bottom wall 25 of the tank 4 without protruding into the tank 4.

The rectilinear tube 20 is integrally formed with a sump 30 of the tank 4, shown in FIGS. 1-2 as a cup-shaped body independent of the tank 4 upper portion and fluid tightly mounted under the tank against the bottom wall 25 of the tank upper portion. The rectilinear tube 20 is mounted under the bottom wall 25. The sump 30 hydraulically communicates with the inside of the tank 4 through an opening 32 in the bottom wall 25.

Preferably, the sump 30 is formed in one piece by moulding a synthetic plastic material and carries integrated therewith not only the rectilinear tube 20, but also an overflow tube 35 for the tank 4, which is connected to a corresponding draining pipe 36 for any excess liquid L.

The rectilinear tube 20 includes an outlet opening 40 at the second end 24 facing the tank 4. The opening 40 is arranged flush with an internal surface 41 of a side wall 44 of the device 10. As shown in FIG. 2, the opening 40 exists along the side wall of the sump 30, so that when the sump 30 contains liquid L as shown in FIG. 2, the rectilinear tube 20 is exposed to the liquid L through the outlet opening 40. The outlet opening 40 as shown consists of the side wall of the sump 30, with respect to which the rectilinear tube 20 protrudes obliquely from the outside of the tank 4 as shown, in particular obliquely and overhangingly, upwards and laterally on the outside of the sump 30 and frontally with respect to the same, at least in part under the tank 4.

The device 10 further includes shielding means 50 arranged at the second end 24 of the rectilinear tube 20 and arranged at least in part facing the end 24, in particular in front of the outlet opening 40 and at a given distance therefrom which is measured parallel to the axial extension of the tube 20, to create a siphon between the tube 20 and the tank 4 inside the sump 30.

The shielding means 50 comprises a radially internal projection 51 of the rectilinear tube 20 arranged flush with the outlet opening 40 for effectively choking the passage section of the rectilinear tube 20; and a baffle 52. The baffle 52 is positioned at a predetermined distance in front of the outlet opening 40 and the choking protrusion 51, in the mentioned parallel direction to the axial extension of the tube 20. The sump 30 is delimited by a cylindrical side wall 44, and the baffle 52 is made as a curved bulkhead which follows the curvature of the wall 44 and which is arranged, in plan, essentially according to a cord of the circular perimeter of the wall 44.

The upper edge of the baffle 52 is at a higher level than the lower edge of the projection 51, so that the lower end 24 of the tube 20 indeed defines, along with the baffle 52 and the projection 51, a siphon towards the sump 30 and the tank 4, which forces the liquid L to take a tortuous, S-shaped path to rise along the tube 20 and which, above all, avoids the complete emptying of the end 24 of the tube 20 from the liquid L also when the level of liquid L in the tank 4 and in the sump 30 is close to zero.

The upper end 23 of the tube 20 is closed by a fluid-tight seal formed by the screw-on cap 22, so as to define a chamber 60 in which the air contained in the tube 20 remains trapped between the cap 22 and the surface height of the liquid L which rises along the tube 20 from the sump 30.

In particular, the screw-on cap 22 is cup-shaped and screwed onto an external threaded segment 61 of the end 23 of the tube 20. The rectilinear tube 20 is externally provided, at the end of the threaded segment 61, with an annular seat 62 for a seal ring 63 (o-ring type) arranged so that the seal ring 63 cooperates with a side wall segment 65 of the screw-on cap 22 free from threading when the screw-on cap 22 is fitted and screwed onto the end 23.

The hose-carrier nipple 13 protrudes axially from a bottom wall 70 of the screw-on cap 22 in an offset position with respect to the tube 20, preferably in a symmetric position with respect to a cylindrical pin 72 protruding axially from the bottom wall 70 of the screw-on cap 22 and parallel to the hose-carrier nipple 13. Furthermore, the cap 22 laterally presents a prismatic shape, so that it can be easily and firmly grasped, either by hand or by means of a gripping tool, either at its side wall or if necessary by means of the nipple 13 and the pin 72.

In use, the device 10 is fitted underneath the tank 4 when the tank 4 is empty and therefore the tube 20 is full of air. When the liquid L fills the tank 4 and the sump 30 underneath, it rises along the tube 20 from the lower end 20, into which it penetrates through the outlet opening 40 (which is not obstructed by the projection 51) and thus compresses the air inside the tube 20 towards the top 23 to completely collect it in the chamber 60. Consequently, the pressure of the air at the nipple 13 rises according to the level of the liquid L, thus allowing the pressure switch 12 to emit a signal proportional to such a level.

To remove dirt accumulated in the tube 20, it is sufficient to remove the panel 6 and the cap 22 when the tank 4 is empty and to introduce through the end 23 thus opened a cleaning instrument, e.g. a brush, which can thus reach the opening 40 and the siphon defined by the projection 51 and the baffle 52 without obstruction.

1. An integrated device for detecting the liquid level in a tank of a dishwashing machine, of the type comprising an airtight bell connected on one side to the tank and on the opposite side to a pressure switch by means of a hose-carrier nipple; characterised in that the airtight bell is defined by a rectilinear tube designed to obliquely protrude, in use, from underneath the tank and externally to the same, towards a front panel of a casing of the household appliance, and by a screw-on cap externally provided with the nipple for connecting to the pressure switch and which fluid-tightly closes a first end of the rectilinear tube, facing the front panel in use; a second end of the rectilinear tube, opposite to the first, being hydraulically connectable to the tank substantially in correspondence with a bottom wall of the same but without protruding inside the tank.

2. A device according to claim 1, characterised in that said second end of the rectilinear tube presents an outlet opening arranged flushed with an internal surface of a side wall of the device exposed in use to the liquid present in the tank, with respect to which the rectilinear tube protrudingly and obliquely extends, laterally on the outside of the tank.

3. A device according to claim 2, characterised in that said rectilinear tube is integrally obtained in one unitary piece with a sump for the tank adapted to fluid-tightly couple in use with the same in position immediately underneath the bottom wall of the tank; said outlet opening of the second end of the rectilinear tube being arranged flushed with the internal surface of a side wall of the sump, with respect to which the rectilinear tube protrudingly and obliquely extends, laterally on the outside of the sump and at least in part under the tank.

4. A device according to claim 2, characterised in that it comprises shielding means arranged at said second end of the rectilinear tube.

5. A device according to claim 4, characterised in that said shielding means are arranged at least in part in front of said second end of the rectilinear tube, to create a siphon between the latter and said tank in use.

6. A device according to claim 4, characterised in that said shielding means comprise a radially internal projection of the rectilinear tube arranged flushed with said outlet opening of the second end of the same for superiorly chocking the passage section of the rectilinear tube, towards the tank.

7. A device according to claim 6, characterised in that said shielding means further comprise a baffle arranged in front of said outlet opening and said choking protrusion, at a predetermined distance from the same on the side facing said tank.

8. A device according to claim 1, characterised in that said screw-on cap is cup-shaped and screwed onto an externally threaded segment of said first end of the rectilinear tube, the latter being externally provided, at the end of said threaded segment, with an annular seat for a seal ring arranged so that the seal ring cooperates with a side wall segment of the screw-on cap free from threading when the screw-on cap is fitted and led onto the first end of the rectilinear tube.

9. A device according to claim 8, characterised in that said hose-carrier nipple is axially and protrudingly obtained on a bottom wall of the screw-on cap, externally to the same and in an offset position with respect to said rectilinear tube, preferably in symmetric position with respect to a cylindrical pin carried axially and protrudingly by the bottom wall of the screw-on cap, parallelly to the hose-carrier nipple.

10. A dishwashing machine, comprising a washing compartment delimited by a casing of the electric household appliance and, inferiorly, by a collection tank for a washing liquid, and accessible through a door of the casing, comprising a device for detecting the level of liquid in the tank accommodated in the casing and comprising in turn an airtight bell connected on one side to the tank and on the other to a pressure switch by means of a hose-carrier nipple; characterised in that the airtight bell is defined by a rectilinear tube which obliquely protrudes underneath the tank and externally to the same, towards a removable front panel of the casing, and by a screw-on cap externally provided with the nipple for connecting to the pressure switch and which fluid-tightly closes a first end of the rectilinear tube, facing said front panel; a second end of the rectilinear tube, opposite the first, being hydraulically connected to the tank substantially in correspondence with a bottom wall of the same, but without protruding into the tank.

11. A dishwashing machine according to claim 10, characterised in that said rectilinear tube is integrally obtained in one unitary piece with a sump for the tank fluid-tightly mounted under the same; the rectilinear tube presenting an outlet opening for the second end towards the tank arranged flushed with an internal surface of a side wall of the sump, with respect to which the rectilinear tube obliquely and protrudingly extends, upwards and laterally on the outside of the sump and at least in part under the tank.

12. An integrated device for detecting the liquid level in a tank of a dishwashing machine, comprising an airtight bell having one side associated with the tank and an opposite side associated with a pressure switch by a hose-carrier nipple;
characterised in that the airtight bell is defined at least in part by
a rectilinear tube obliquely protruding from a lower portion of the tank towards a front panel of a casing of the appliance, and
a screw-on cap, provided with the nipple for connecting to the pressure switch, which creates a fluid-tight seal that closes a first end of the rectilinear tube, the first end facing the front panel;
wherein a second end of the rectilinear tube, opposite the first, is substantially in correspondence with a bottom wall of the tank but without protruding inside the tank.

13. A device according to claim 12, characterised in that said second end of the rectilinear tube presents an outlet opening arranged flush with an internal surface of a side wall of the device, the surface is exposed in use to the liquid present in the tank, the rectilinear tube laterally and obliquely protrudes from the side wall on the outside of the lower portion of the tank.

14. A device according to claim 13, characterised in that said rectilinear tube is integrally formed with a sump that forms the lower portion of the tank, the sump adapted to couple with an upper portion of the tank in a position immediately underneath a bottom wall of the upper portion of the tank, the coupling being fluid tight; said outlet opening of the second end of the rectilinear tube being arranged flush with the internal surface of a side wall of the sump, the rectilinear tube laterally and obliquely protrudes from the outside of the sump and at least in part under the upper portion of the tank.

15. A device according to claim 13, characterised in that the device further comprises shielding means arranged at said second end of the rectilinear tube.

16. A device according to claim 15, characterised in that said shielding means is arranged at least in part in front of said second end of the rectilinear tube, to create a siphon between said rectilinear tube and said tank in use.

17. A device according to claim 15, characterised in that said shielding means comprises a radially internal projection of the rectilinear tube arranged flush with said outlet opening of said second end for choking the passage section of the rectilinear tube.

18. A device according to claim 17, characterised in that said shielding means further comprises a baffle arranged in front of said outlet opening and said choking protrusion at a predetermined distance on the side facing said tank.

19. A device according to claim 12, characterised in that said screw-on cap is cup-shaped and screwed onto an externally threaded segment of said first end of the rectilinear tube, the rectilinear tube being externally provided, at the end of said threaded segment, with an annular seat for a seal ring arranged so that the seal ring cooperates with a side wall segment of the screw-on cap free from threading when the screw-on cap is fitted and led onto the first end of the rectilinear tube.

20. A device according to claim 19, characterised in that said hose-carrier nipple protrudes axially from a bottom wall of the screw-on cap, externally to the screw-on cap and in an offset position with respect to said rectilinear tube, preferably in symmetric position with respect to a cylindrical pin protruding axially from the bottom wall of the screw-on cap and parallel to the hose-carrier nipple.
